(19) United States
(12) Patent Application Publication
(10) Pub. No.: US 2014/0248431 A1
(43) Pub. Date: Sep. 4, 2014

(54) METHOD OF PREPARATION FOR FLAME RETARDING COMPOSITION

(71) Applicants: Aziz Khadbai, Plano, TX (US); Josea Roberts Sparkling, McKinney, TX (US); James Burton Anderson, McKinney, TX (US); Ian Douglas Buchanan, McKinney, TX (US)

(72) Inventors: Aziz Khadbai, Plano, TX (US); Josea Roberts Sparkling, McKinney, TX (US); James Burton Anderson, McKinney, TX (US); Ian Douglas Buchanan, McKinney, TX (US)

(21) Appl. No.: 13/782,524

(22) Filed: Mar. 1, 2013

(51) Int. Cl. C09D 5/18

(52) U.S. Cl. CPC C09D 5/18
USPC 427/299

(57) ABSTRACT

The present invention teaches an acrylic or latex comprising flame retarding composition. The composition comprises: Sodium polyacrylates, Acrylic Polymer Solution, Silicone Surfactant, Titanium Dioxide Pigment, Ammonium Polyphosphate, Mono-Pentacrythritol, Melamine powder, Hydrogen Peroxide, Hydroxyethyl Cellulose, Ester Alcohol, Acrylic Copolymer Emulsion, Soda Lime Borosilicate Glass, Hydrophobically Modified Ethylene Oxide Urethane and Distilled Water. The flame retarding composition fully satisfies the Federal Aviation Regulation (FAR) 25.853(a) vertical burn test, and Federal Aviation Regulation (FAR) 25.853(d) heat release test. The acrylic or latex comprising flame retarding composition is equally useful for prepared or non-prepared substrate surfaces. The utility of the present invention extends to numerous commercial and non-commercial applications.

### CROSS-REFERENCE TO RELATED APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the present invention generally relate to fire or flame retardation. More particularly, the present invention relates to a chemical composition including acrylic or latex as a binder for flame retardation. The chemical composition is effective for flame retardation for a plurality of combustible materials including, but not limited to, honeycomb non-metallic structural materials, a variety of plastics, synthetic wood, composite materials, fiber-glass, and textiles from synthetic or non-synthetic fibers.

### BACKGROUND OF THE INVENTION

Industry is moving away from metallic structural members and panels, including vehicle and aircraft industry. Metallic structural members and panels have high weight to strength ratios. In other words, the higher the strength of the metal structural members and panels, the higher the weight. The resulting demand for alternative material structural members and panels has, thus, increased. Because of their low weight to strength ratios and corrosion resistance, non-metallic panels have become useful as structural members in vehicle, aircraft and many other industries.

Many structural or non-structural applications (commercial or non-commercial) may demand the use of combustible materials, including, but not limited to, honeycomb structural non-metallic materials, plastics, synthetic wood, fiber glass and composite materials for various purposes. Fire safety regulations require that combustible materials used in non-commercial or commercial applications be treated with flame retardant chemical compositions. In efforts to comply with these regulations, manufacturers may apply fire retardant chemical compositions to their goods. Unfortunately, many fire retardant compositions are known to be toxic to humans and the environment. For example, fire resistant compositions may include halogenated, particularly those with the halogens chlorine and bromine. Bromine flame retardants (BFRs) and Chlorinated flame retardants (CFRs) are known to cause rapid accumulation inside the human body with critical adverse effects, such as immune system suppression, cancer, endocrine disruption, neurobehavioral and developmental effects. BFRs are used widely in consumer products, especially in plastics for electronics, foams, and textiles. It is also suspected that CFRs used in textiles, paints and coatings, plastics, and insulation foams may cause harm to humans and the environment. It is to be pointed out that non-halogenated flame retardants are needed to reduce or eliminate the use of BFRs and CFRs. Accordingly, there is a need for acrylic or latex based flame retardant composition that is not harmful to humans or environment, and provides good adherence of flame retardant composition to the substrate surfaces.

The present invention is unique as there is no finding in prior art that teaches, or suggests fire retarding composition as it is depicted in the present invention. The present invention is equally useful for prepared and non-prepared substrate surfaces. The present invention uniquely fulfills the aforementioned need effectively and efficiently. The utility of the present invention extends to numerous commercial and non-commercial applications.

### SUMMARY OF THE INVENTION

To achieve the forgoing and other objectives and in accordance with the purpose of the present invention, the fire retarding composition and method of its application is presented. It is to be understood that the present invention is not limited to the particular methodology, system, techniques, uses, and applications, described herein, as these may vary. It is also to be understood that the terminology used herein is used for the purpose of describing particular embodiments only, and is not intended to limit the scope of the present invention.

In one embodiment of the present invention, a three-step method (step-1, step-2, and step-3) for an exemplary sequence of the mode of action for a flame retarding or inhibiting composition is provided. The flame retarding composition for the three-step method, without limitation, comprises: Tamol™ 731A (Sodium polyacrylates), Rhodoline® 226/35 (Acrylic Polymer Solution), BYK® 346 (Silicone Surfactant), Titanium Dioxide Pigment, Exolit AP® 422 (Ammonium Polyphosphate), Tech PE® 200 (Mono-Pentacrythritol), Melamine powder, Hydrogen Peroxide, Natrasol® 250 MXR (Hydroxyethyl Cellulose), Texanol™ (Ester Alcohol), StanChem® 5174 (Acrylic Copolymer Emulsion), Scotchlite™ K25 (Soda Lime Borosilicate Glass), Acrysol™ RM-8W (Hydrophobically Modified Ethylene Oxide Urethane) and Distilled Water.

In another embodiment of the present invention, step-1 of the method for an exemplary sequence of the mode of action for a flame retarding composition solution, without limitation, comprises: mixing under stirring about 0.14% to about 0.16% by weight of Tamol™ 731A (Sodium polyacrylates), about 0.18% to about 0.20% by weight of Rhodoline® 226/35 (Acrylic Polymer Solution), about 0.04% to about 0.05% by weight of BYK® 346 (Silicone Surfactant) into about 27.50% to about 28.12% by weight of distilled water to form step-1 solution.

In another embodiment of the present invention, step-2 of the method for an exemplary sequence of the mode of action for a flame retarding composition solution, without limitation, comprises: mixing under stirring into already prepared step-1 solution about 7.30 to about 7.39% by weight of Titanium Dioxide Pigment, about 20.60 to about 20.69% by weight of Exolit® AP 422 (Ammonium Polyphosphate), about 8.90% to about 9.00% by weight of TECH PE® 200 (Mono-Pentacrythritol), about 9.40% to about 9.45% by weight of Melamine Powder, and about 0.29% to about 0.31% by weight of Natrasol™ 250 MXR (Hydroxyethyl Cellulose) to form step-2 solution.

In another embodiment of the present invention, step-3 of the method for an exemplary sequence of the mode of action for a flame retarding composition, without limitation, comprises: mixing under stirring about 0.02% to about 0.03% by weight of Hydrogen Peroxide, about 0.70% to about 0.75% by weight of Texanol™ (Ester Alcohol), about 2.77% to about 21.77% by weight of StanChem® 5174 (Acrylic Copolymer Emulsion), about 1.42% to about 1.52% by weight of Scotchlite™ K25 (Soda Lime Borosilicate Glass) and about 0.46% to about 0.56% by weight of Acrysol™ RM-8W (Hydrophobically Modified Ethylene Oxide Urethane) to form step-3 solution. The step-3 solution is complete and ready to use flame retarding composition solution.

In another embodiment of the present invention, a device for an exemplary sequence of the mode of action, the viscosity of flame retarding composition solution after step-3 composition is maintained about 1500 centipoise to about 1800 centipoise.

In another embodiment of the present invention, a device for an exemplary sequence of the mode of action for preparing the substrate surfaces for the application or treatment of flame retarding composition solution. The surfaces are prepared by creating micro-voids or micro-cavities by treating the surfaces by mechanical or chemical means.

In another embodiment of the present invention, a device for an exemplary sequence of the mode of action, the flame retarding composition solution is applied to substrate surfaces by painting, dipping or spraying means.

In another embodiment of the present invention, a device for an exemplary sequence of the mode of action, the flame retarding composition solution fully satisfies the Federal Aviation Regulation (FAR) 25.853(a) vertical burn test, and Federal Aviation Regulation (FAR) 25.853(d) heat release test.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is an illustration of exemplary schematic depicting the process for preparing the flame retarding composition solution.

### DETAILED DESCRIPTION OF THE EMBODIMENTS

The present invention is best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it must be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this Application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable sub-combination. The Applicants hereby give notice that new Claims may be formulated to such features and/or combinations of such features during the prosecution of the present Application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As it is well known to those skilled in the art many careful considerations and compromises typically must be made when designing for the optimal manufacture of a commercial implementation of any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

It is to be understood that any exact measurements/dimensions or particular construction materials indicated herein are solely provided as examples of suitable configurations and are not intended to be limiting in any manner. Depending on the needs of the particular application, those skilled in the art will readily recognize, in light of the following teachings, a multiplicity of suitable alternative implementation details.

It is to be, specifically, emphasized that any teaching or combination of teachings, any novel feature, or any novel combination of features including the novel processing mechanism, or any combination of novel processing mechanisms for the flame retarding composition solution and its method of application, in accordance with an embodiment of the present invention, is clearly distinguished form the prior art, because no prior art is found either alone or in combination that teaches all of the features of the present invention.

To achieve the forgoing and other objectives and in accordance with the purpose of the present invention, the flame retarding composition solution and its method of application or treatment is presented. It is to be understood that the present invention is not limited to the particular methodology, system, techniques, uses, and applications, described herein, as these may vary. It is to be understood that the terminology used herein is used for the purpose of describing particular embodiments only, and is not intended to limit the scope of the present invention.

The present invention is illustrated by way of example, and not by way of limitation, in the figures of the accompanying drawings and in which like reference numerals refer to similar elements and in which:

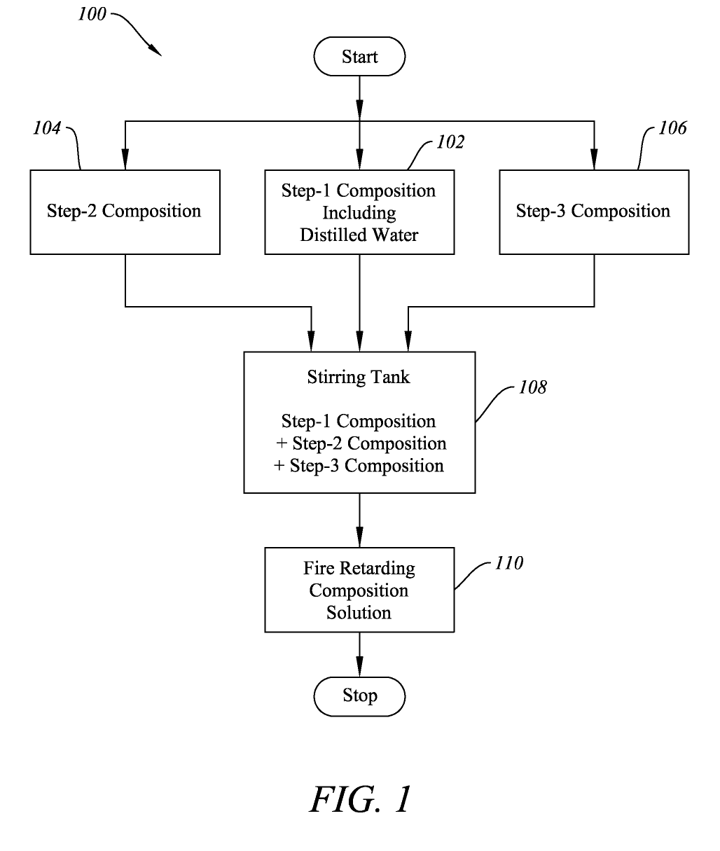

FIG. 1 is an illustration of exemplary schematic depicting the process for preparing the flame retarding chemical composition in accordance with an embodiment of the present invention. The schematic 100 illustrates an integrated three-step (step-1, step-2, and step-3) process for the flame retarding composition solution. The schematic 100 depicts step-1102 of the composition solution method for an exemplary sequence of the mode of action for a flame retarding composition comprises: mixing under continuous stirring about 0.14% to about 0.16% by weight of Tamol™ 731A (Sodium Polyacrylates), about 0.18% to about 0.20% by weight of Rhodoline® 226/35 (Acrylic Polymer Solution), about 0.04% to about 0.05% by weight of BYK® 346 (Silicone Surfactant) into about 27.50% to about 28.12% by weight of distilled water to form step-1 solution. First, water is added into the stirring tank (108) followed by the remaining chemical compounds as numerated in step-1 (102). The stirring means include mechanical, ultrasound or magnetic stirring, or any combination thereof. Depending on mass volume of chemical compounds, stirring is continued for a sufficient time to ensure complete and homogeneous mixing of chemical compounds in the stirring tank (108).

Referring again to FIG. 1, step-2 104 of the method for an exemplary sequence of the mode of action for a flame retarding composition solution comprises: about 7.30 to about 7.39% by weight of Titanium Dioxide Pigment, about 20.60 to about 20.69% by weight of Exolit® AP 422 (Ammonium Polyphosphate), about 8.90% to about 9.00% by weight of TECH PE® 200 (Mono-Pentacrythritol), about 9.40% to about 9.45% by weight of Melamine Powder, and about 0.29% to about 0.31% by weight of Natrasol™ 250 MXR (Hydroxyethyl Cellulose). Adding and mixing under continuous stirring chemical compounds from step-2 into step-1 solution in the stirring tank (108) to form step-2 solution. Again, stirring is continued for a sufficient time to ensure complete and homogeneous mixing of chemical compounds from step-2 104 and previously mixed chemical compounds from step-1102 in the stirring tank 108.

Referring again to FIG. 1, in one embodiment of the present invention, the schematic 100 depicts step-3 method for an exemplary sequence of the mode of action for a flame retarding composition solution comprises: about 0.02% to about 0.03% by weight of Hydrogen Peroxide, about 0.70% to about 0.75% by weight of Texanol™ (Ester Alcohol), about 2.77% to about 21.77% by weight of StanChem® 5174 (Acrylic Copolymer Emulsion), about 1.42% to about 1.52% by weight of Scotchlite™ K25 (Soda Lime Borosilicate Glass) and about 0.46% to about 0.56% by weight of Acrysol™ RM-8W (Hydrophobically Modified Ethylene Oxide Urethane). Adding and mixing under continuous stirring chemical compounds from step-3 106 into pre-existing contents in the stirring tank 108 to form the ready to use flame retarding composition solution. Again, stirring is continued for a sufficient time to ensure complete and homogeneous mixing of all the chemical compounds from step-1102, step-2104 and step-3106 in the stirring tank 108. The viscosity of the ready to use flame retarding composition solution 110 is maintained about 1500 centipoise to about 1800 centipoise.

We claim:

1. A method of preparing flame retarding composition comprising:
Selecting at least one chemical composition from the group of Sodium polyacrylates, Acrylic Polymer Solution, Silicone Surfactant, Titanium Dioxide Pigment, Ammonium Polyphosphate, Mono-Pentacrythritol, Melamine powder, Hydrogen Peroxide, Hydroxyethyl Cellulose, Ester Alcohol, Acrylic Copolymer Emulsion, Soda Lime Borosilicate Glass, Hydrophobically Modified Ethylene Oxide Urethane and Distilled Water.
mixing said at least one chemical composition in said distilled water heated to about 90 degree C. to form a flame retarding composition solution;
preparing a substrate surfaces for said flame retarding composition solution treatment; and
treating said substrate surfaces with said flame retarding composition solution.

2. The method of claim 1, wherein said flame retarding composition solution is completed in step-1, step-2 and step-3 processing sequence.

3. The method of claim 2, wherein said step-1 comprises: mixing under stirring about 0.14% to about 0.16% by weight of Sodium polyacrylates, about 0.18% to about 0.20% by weight of Acrylic Polymer Solution, about 0.04% to about 0.05% by weight of Silicone Surfactant into about 27.50% to about 28.12% by weight of said distilled water to form said step-1 solution.

4. The method of claim 2, wherein said step-2 comprises: mixing under stirring into said step-1 solution about 7.30 to about 7.39% by weight of Titanium Dioxide Pigment, about 20.60 to about 20.69% by weight of Ammonium Polyphosphate, about 8.90% to about 9.00% by weight of Mono-Pentacrythritol, about 9.40% to about 9.45% by weight of Melamine Powder, about 0.29% to about 0.31% by weight of Hydroxyethyl Cellulose to form said step-2 solution.

5. The method of claim 2, wherein said step-3 comprises: mixing under agitation about 0.02% to about 0.03% by weight of Hydrogen Peroxide, about 0.70% to about 0.75% by weight of Ester Alcohol, about 2.77% to about 21.77% by weight of Acrylic Copolymer Emulsion, about 1.42% to about 1.52% by weight of Soda Lime Borosilicate Glass and about 0.46% to about 0.56% by weight of Hydrophobically Modified Ethylene Oxide Urethane to form said step-3 solution, and wherein said step-3 solution is ready to use said flame retarding composition solution.

6. The method of claim 5, wherein viscosity of said flame retarding composition solution is maintained about 1500 centipoise to about 1800 centipoise.

7. The method of claim 6, wherein said flame retarding composition solution is applied to prepared or non-prepared substrate surfaces by coating, dipping or spraying means, and wherein said prepared surfaces are achieved by mechanical or chemical processing means.

8. The method of claim 6, wherein said flame retarding composition solution is applied to fabrics by coating, dipping or spraying means, and wherein said fabrics include synthetic or natural yarn.
